(19) United States
(12) Patent Application Publication
(10) Pub. No.: US 2013/0087434 A1
(43) Pub. Date: Apr. 11, 2013

(54) CONVEYOR DEVICE

(71) Applicants: Steffen Fickeisen, Bad Durkheim (DE); Joschka Neumann, Mannheim (DE)

(72) Inventors: Steffen Fickeisen, Bad Durkheim (DE); Joschka Neumann, Mannheim (DE)

(73) Assignee: JOSEPH VOGELE AG, Ludwigshafen/Rhein (DE)

(21) Appl. No.: 13/640,589

(22) PCT Filed: Apr. 13, 2011
(86) PCT No.: PCT/EP11/01879

§ 371 Date: Dec. 28, 2012

(30) Foreign Application Priority Data
Apr. 16, 2010 (EP) 10004060.9

(51) Int. Cl. B65G 15/60

(52) U.S. Cl. CPC B65G 15/60
USPC 198/812

(57) ABSTRACT

The invention relates to a conveyor device (20), wherein the conveyor device (20) comprises a frame, guide elements (10) supported by the frame, and a conveyor belt (7) guided around the guide elements (10). The invention is characterized in that the frame is assembled from a plurality of frame modules (21, 22, 23), wherein at least one of the frame modules (21, 22, 23) is exchangeable in order to alter the length of the conveyor device (20).

The present invention relates to a conveyor device according to the preamble of claim 1. It is in particular a conveyor device at or on a construction machine for conveying material to be processed by the construction machine. The construction machine can be, for example, a road milling machine which mills off a road surface to be replaced. This road surface is then transported away by means of the conveyor device. The construction machine can also be a road finishing machine or a charger (feeder) for a road finishing machine. The transported material is in this case a road-surfacing mix employed for producing traffic area pavements.

From DE 298 12 115 U1, a feeder with a generic conveyor device is known. The conveyor device comprises a first conveyor belt which is firmly installed on the feeder. To increase the transport length, a second conveyor belt which is served by the first conveyor belt can be fixed to a boom behind the feeder.

A disadvantage of the conventional conveyor device is that it is comparably complicated to change the conveyor length. To change the conveyor length, a complex and heavy additional device with the second conveyor belt must be attached to the feeder.

It is the object of the invention to improve a conventional conveyor device with means constructively as simple as possible, such that the amount of time and work required to change the length of the conveyor device is reduced.

This object is achieved by a conveyor device having the features of claim 1. Advantageous further developments of the invention are stated in the sub-claims.

In the conveyor device according to the invention, the frame which supports the guide elements for the conveyor belt is composed of several frame modules, wherein at least one of the frame modules can be exchanged to change the length of the conveyor device. The advantage of the invention is that for changing the length of the conveyor device, it is no longer necessary to attach or remove an additional conveyor belt or to replace a complete conveyor belt by a shorter or longer conveyor belt. In the invention, it is rather sufficient to exchange one or several frame modules of the frame of the conveyor device to change the length of the conveyor device. The exchangeable frame module or the exchangeable frame modules are removably fixed to the adjacent frame module or frame modules.

Preferably, a frame module at the front end of the conveyor device (i.e. at the receiving point of the conveyor device), at the rear end of the conveyor device (i.e. at the discharge point of the conveyor device), and/or in a central section of the conveyor device can be exchanged. Here, the possibility of exchanging a frame module at the rear end of the conveyor device is particularly advantageous as this rear end is usually particularly easily accessible.

It is conceivable for not only one frame module but several frame modules of the conveyor device to be exchangeable. This offers more possibilities of adjusting the length of the conveyor device, and/or a more extensive change of the length can be realized.

It is particularly advantageous to have a set or a group of interchangeable frame modules by which the length of the conveyor device is variable without changing the length of the conveyor belt in the process. This offers the advantage that only the frame modules have to be exchanged without having to simultaneously exchange the conveyor belt. For example, each module of the set of frame modules can comprise an internal guide section for the conveyor belt, so that the effective length of the conveyor belt within each of the interchangeable frame modules is the same.

A stable use of two frame modules can be achieved by two adjacent frame modules being interconnectable by means of a flange connection.

The conveyor device according to the invention can be mounted to a road finishing machine or a feeder (charger) for a road finishing machine.

It is suitable to permanently fix a base frame module of the conveyor device to the road finishing machine or the feeder. This base frame module can form a stable base of the conveyor device. The drive of the conveyor belt, for example a drive for a guide roller, can also be permanently fixed to the road finishing machine or to the construction machine supporting the conveyor device.

Below, an advantageous embodiment of the invention will be illustrated in more detail with reference to a drawing. The drawings show in detail:

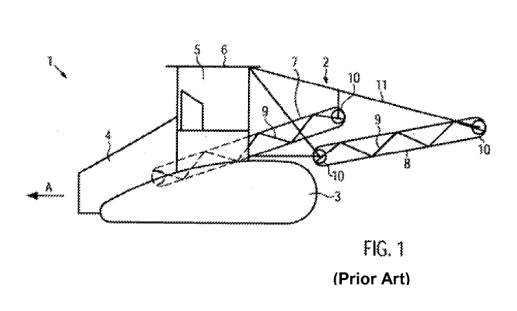

FIG. 1 a feeder with a conventional conveyor device,

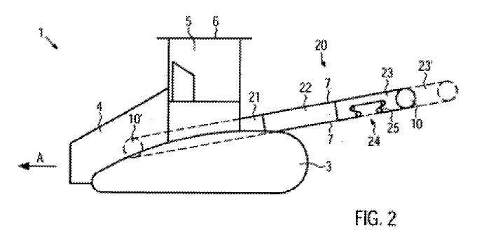

FIG. 2 a feeder with a conveyor device according to the invention, and

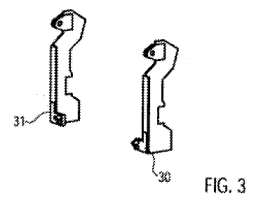

FIG. 3 a perspective view of the flange connection.

Equal components are always provided with equal reference numerals in the figures.

FIG. 1 shows a construction machine 1, in particular a feeder for a road finishing machine, with a conventional conveyor device 2. The feeder 1 comprises a running gear 3, in particular a crawler running gear. A material bunker 4 at the front end of the feeder 1, seen in the working direction A, serves to receive and store a road-surfacing mix, for example concrete or a hot bituminous road-surfacing mix. The feeder 1 is operated and driven from a control cabin 5. The control cabin 5 is protected by a roof 6.

The conveyor device 2 comprises a first conveyor belt 7 and a second conveyor belt 8. It further comprises, for each of the two conveyor belts, a frame 9 which supports deflecting elements (viz. guide elements), in particular guide rollers 10 around which the conveyor belt 7, 8 is guided and deflected. One of the guide rollers 10 each for each conveyor belt 7, 8 is driven to move the conveyor belt 7, 8.

The first conveyor belt 7 starts with its front end in the material bunker 4 to receive the material from there. The end or the discharge point, respectively, of the first conveyor belt 7 is situated above the receiving point or the front end of the second conveyor belt 8, respectively. The frame 9 of the second conveyor belt 8 is supported at the machine body of the construction machine 1 via one or several booms 11.

FIG. 2 shows the same feeder 1 as in FIG. 1, but now with a conveyor device 20 according to the invention. The conveyor device 20 also comprises a conveyor belt 7. However, it differs from the conveyor device 2 shown in FIG. 1 in that the frame 9 of the conveyor device is composed of several modules 21, 22, 23, that is a front frame module 21, a central frame module 22, and a rear frame module 23.

The front frame module 21 can be permanently fixed to the construction machine 1 as a base frame module. It supports the front guide roller 10′ via which the conveyor belt 7 is driven.

The central frame module 22 and the rear frame module 23 are removably fixed to each other and to the first frame module 21; they can be exchanged to be replaced by a shorter or longer frame module 22, 23.

A first rear frame module 23 is shown in a solid line. It comprises a deflecting device 24 with several guide rollers 25 to receive an excessive length of the conveyor belt 7. The deflecting device 24 can be simultaneously used for tensioning the conveyor belt 7.

The rear frame module 23 can be replaced by a longer rear frame module 23′ drawn in a dashed line. With the longer rear frame module 23′, the position of the rear guide roller 10 is offset further to the rear. The excessive length of the conveyor belt 7 previously received in the deflecting device 24 is now used to be able to also guide the conveyor belt around the rear guide roller 10 further offset to the rear. The longer frame module 23′ can therefore do without any additional deflecting device 24 as the conveyor belt 7 now no longer is excessively long.

FIG. 3 shows a right flange 30 and a left flange 31. These flanges are fixed to the facing ends of the respective frame modules 21, 22, 23. They are used to removably fix the frame modules to each other.

Starting from the represented embodiment, the conveyor device according to the invention can be modified in many ways. It is conceivable, for example, to also be able to exchange the front frame module 21. It can moreover be possible to insert further frame modules into the conveyor device 20, so that the frame 9 is composed of more than three modules.

1. Conveyor device comprising a frame, guide elements supported by the frame, and a conveyor belt guided around the guide elements, wherein the frame is composed of a plurality of frame modules, at least one of the frame modules is exchangeable to alter the length of the conveyor device, a set of interchangeable frame modules for altering the length of the conveyor device without altering the length of the conveyor belt, wherein a shorter frame module comprises a deflecting device for receiving an excessive length of the conveyor belt, and a longer frame module without such a deflecting device can be exchanged for the shorter frame module.

2. Conveyor device according to claim 1, wherein one of the frame modules is exchangeable at the front end of the conveyor device, at the rear end of the conveyor device, and/or in a central section of the conveyor device.

3. Conveyor device according to claim 1, wherein more than one of the frame modules is exchangeable.

4. Conveyor device according to claim 1, wherein two adjacent frame modules can be interconnected with a means flange connection.

5. Conveyor device according to claim 1, wherein the conveyor device is mounted to a road finishing machine or a feeder.

6. Conveyor device according to claim 5, wherein a base frame module of the conveyor device is permanently affixed to the road finishing machine or the feeder.

7. Conveyor device according to claim 1, wherein the deflecting device comprises a plurality of deflecting rollers for receiving the excessive length of the conveyor belt.

8. Conveyor device according to claim 1, wherein the deflecting device is configured for tensioning the conveyor belt.
